(19) United States
(12) Patent Application Publication
(10) Pub. No.: US 2010/0024171 A1
(43) Pub. Date: Feb. 4, 2010

(54) HINGE AND COLLAPSIBLE DEVICE UTILIZING THE SAME

(75) Inventor: SHIN-YUAN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/250,487

(22) Filed: Oct. 13, 2008

(30) Foreign Application Priority Data
Jul. 30, 2008 (CN) 200820301651.4

(51) Int. Cl. E05D 5/10

(52) U.S. Cl. 16/386

(57) ABSTRACT

A hinge includes a shaft, a first bracket being rotatably mounted on the shaft, an interference assembly including a first element, and a second element, a biasing member, a fastener, and a fixing member. The second element is engaged with and capable of rotating relative to the first element and together with the shaft. The shaft is passed through the first and second elements, the biasing member in turn. The fastener is fixed to a distal end of the shaft, to prevent the interference assembly and the biasing member from disengaging from the shaft. The fixing member is configured for passing through the first element to engage with the first bracket, resulting in fixing the first element to the first bracket. A collapsible device utilizing the hinge is disclosed.

### BACKGROUND

1. Technical Field

The invention relates to a hinge, and a collapsible device utilizing the same.

2. Description of Related Art

A collapsible device, such as a notebook computer, or a clamshell mobile phone, generally includes a base, and a cover pivotably hinged on the base for covering or revealing a surface of the base. The hinge generally includes a male interference element and a female interference element for positioning the cover during rotation. The male interference element includes two raised portions and the female interference element includes two depressed portions for receiving the raised portions. When the male interference element is rotated relative to the female interference element, the raised portions are moved out from the corresponding depressed portions, resulting in friction between the first and second elements, thereby causing the male and female interference elements to wear out. In this process, the male and female interference elements need to be in constant contact with each other for smooth operation, but over time they may wear down and lose contact. Moreover, much force is required to rotate the cover, so that the cover may easily bump hard against the base when the cover is rotated closed.

### BRIEF DESCRIPTION OF THE DRAWINGS

FIG. 1 is an exploded, isometric view of an exemplary embodiment of a hinge including an interference assembly.

FIG. 2 is similar to FIG. 1, but viewed from another perspective.

FIG. 3 is an exploded, isometric view of the interference assembly of FIG. 1.

FIG. 4 is an assembled, isometric view of FIG. 1.

FIG. 5 is an isometric view of an exemplary embodiment of a collapsible device utilizing the hinge of FIG. 4.

### DETAILED DESCRIPTION OF THE EMBODIMENTS

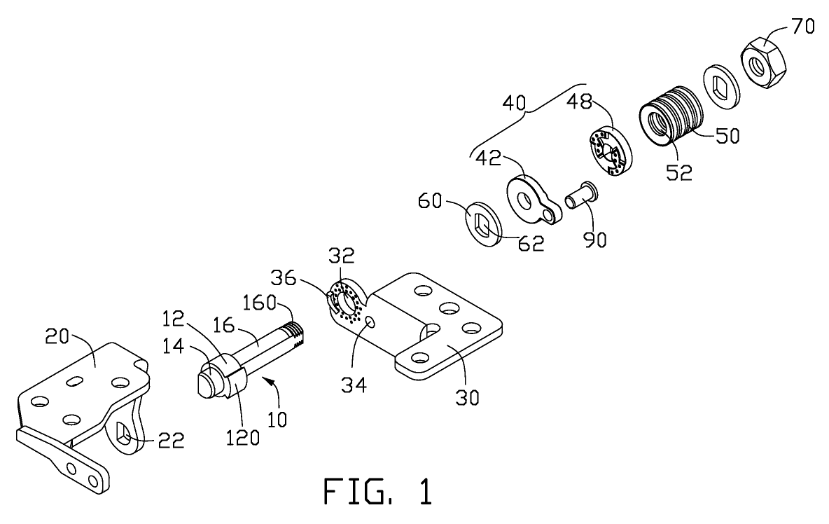

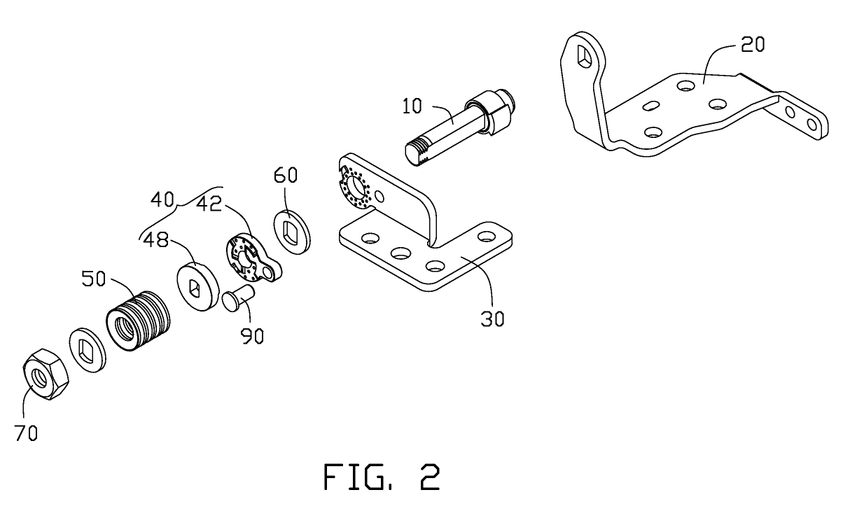

Referring to FIGS. 1 and 2, an exemplary embodiment of a hinge includes a shaft 10, a first bracket 20, a second bracket 30, an interference assembly 40, a biasing member 50, a washer 60, a fastener 70, and a fixing member 90. In one embodiment, the fastener 70 is a screw cap.

The shaft 10 includes a washer-shaped main body 12, a non-circular fixing rod 16 extending from a first end of the main body 12, and a semicircular conjoining portion 14 extending from a second end of the main body 12. The fixing rod 16 has a double-D shaped cross-section, and a free end opposite to the main body 12 of the fixing rod 16 forms a threaded portion 160. A stop portion 120 protrudes from a circumference of the main body 12.

The first bracket 20 defines a semicircular fixing hole 22 for mating with the conjoining portion 14 of the shaft 10.

The second bracket 30 defines a circular through hole 32 for the shaft 10 extending therethrough, and a fastening hole 34 neighboring the through hole 32 therein. An embowed, wedge-shaped blocking portion 36 adjacent to the through hole 32 and opposite to the fastening hole 34 extends from a side of the second bracket 30, facing the first bracket 20.

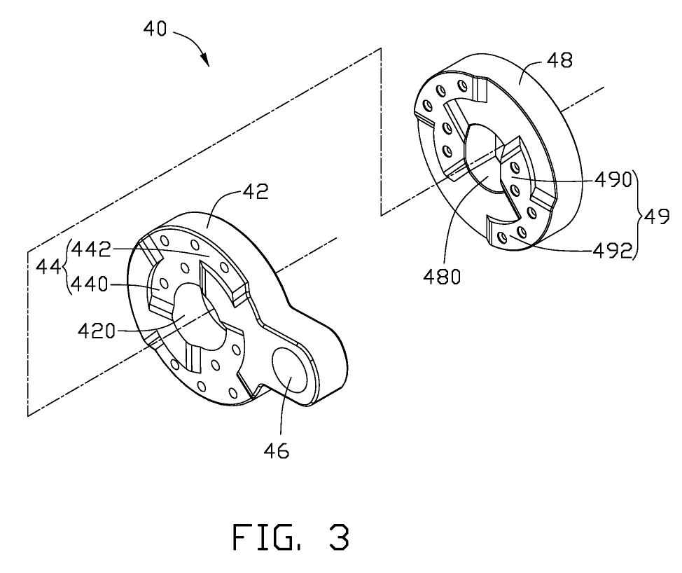

Referring also to FIG. 3, the interference assembly 40 includes a first element 42, and a second element 48 configured to engage with and rotate relative to the first element 42.

The first element 42 is generally washer-shaped and defines a round through hole 420 in a center through from a first side to a second side, for the fixing rod 16 of the shaft 10 passing therethrough. The first side of the first element 42 faces the second element 48 and defines two generally Z-shaped depressed portions 44. The depressed portions 44 are opposite to each other across the through hole 420. Each depressed portion 44 includes a first portion 440 arranged around the through hole 420, and a second portion 442 arranged along a circumference of the first element 52. One end of the first portion 440 is opposite to and communicates with one end of the second portion 442. A protrusion (not labeled) extends from the circumference of the first element 42, with a fixing hole 46 extending from the protrusion along an axial direction of the first element 42.

The second element 48 is generally washer-shaped and defines a double-D shaped fixing hole 480 for non-rotationally fitting about the fixing rod 16 of the shaft 10. The second element 48 includes a first side facing the first side of the first element 42. Two generally Z-shaped raised portions 49 protrude from the first side of the second element 48. The raised portions 49 are opposite to each other across the fixing hole 480. Each raised portion 49 includes a first part 490 arranged around the fixing hole 480, and a second part 492 arranged along a circumference of the second element 48. One end of the first part 490 is opposite to and communicates with one end of the second part 492.

The biasing member 50 includes a plurality of elastic elements horizontally stacked together, and each of the elastic elements defines a through hole 52 for the fixing rod 16 of the shaft 10 passing therethrough.

The washer 60 defines a double-D shaped through hole 62 in a center thereof for non-rotationally fitting about the fixing rod 16 of the shaft 10.

In one embodiment, the fixing member 90 is a rivet.

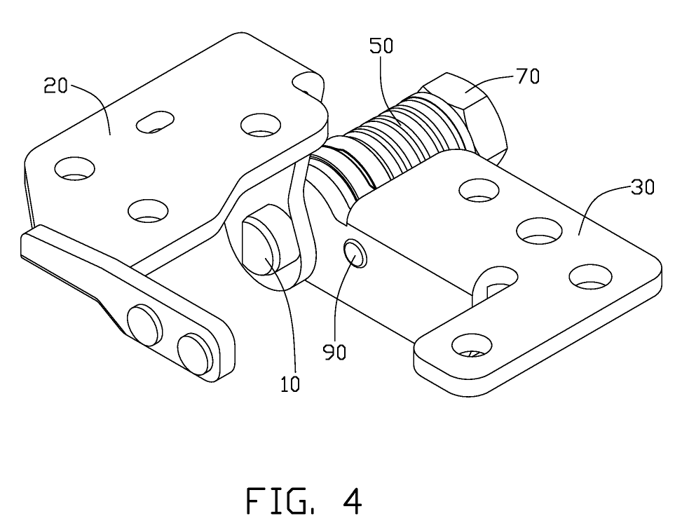

Referring also to FIG. 4, in assembly, the conjoining portion 14 of the shaft 10 is inserted into and fixed in the fixing hole 22 of the first bracket 20, so the shaft 10 can rotate together with the first bracket 20. The fixing rod 16 is passed though the through hole 32 of the second bracket 30, the through hole 62 of the washer 60, the through hole 420 of the first element 42, the fixing hole 480 of the second element 48, and the through holes 52 of the elastic elements of the biasing member 50 in turn. The fastener 70 is engaged with the threaded portion 160 for fixing the fastener 70 to the shaft 10, which is configured for preventing the washer 60, the interference assembly 40, and the biasing member 50 from disengaging from the shaft 10. The washer 60 is fixed to the fixing rod 160 and located between the first element 42 and the second bracket 30, for increasing friction between the second bracket 30 and the first element 42. Accordingly, the first and second elements 42, 48 face each other, and the depressed portions 44 engage with the corresponding raised portions 49. The blocking portion 36 of the second bracket 30 resists against the main body 12. The fixing member 90 is passed through the fixing hole 46, and the fastening hole 34 in turn, as a result, the first element 42 is fixed to the second bracket 30, and the first and second elements 42, 48 firmly resist against each other.

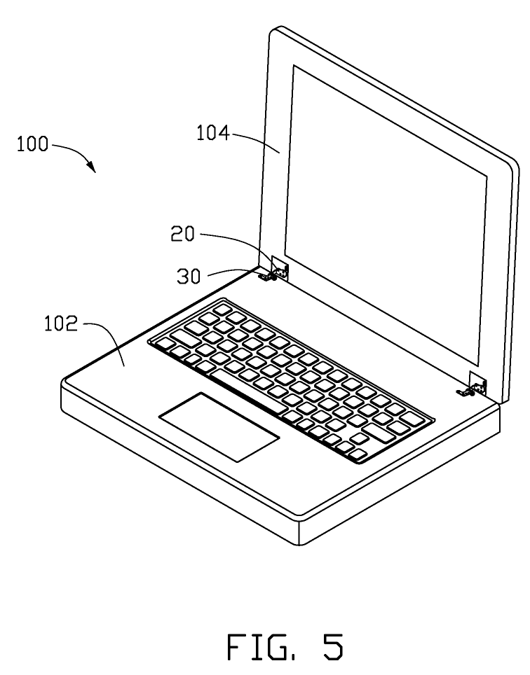

Referring also to FIG. 5, in use, the hinge is utilized in a collapsible device 100, here a notebook computer, that includes a base 102 and a cover 104. The second bracket 30 is fixed to the base 102. The first bracket 20 is fixed to the cover 104, and rotatable together with the cover 104 relative to the base 102.

When the cover 104 is rotated away from the base 102, the first bracket 20 is rotated together with the shaft 10. The second element 48 is rotated with the shaft 10 relative to the first element 42. Because the second raised portions 49 move onto the first side of the first element 42 from bottoms of the depressed portions 44, the second element 48 moves away from the first element 42 along the axial direction. Once the stop portion 120 of the shaft 10 resists against a high end of the blocking portion 36, the cover 104 cannot be rotated any further, resulting in the cover 104 being located at a determined angle relative to the base 102.

When the cover 104 is closed, the cover 104 is rotated toward the base 102. The first bracket 20 is reversely rotated together with the shaft 10, and the second element 48 is rotatable with the shaft 10 relative to the first element 42. Because the second raised portions 49 move into the depressed portions 44 from the first side of the first element 42, the second element 48 moves close to the first element 42 along the axial direction. When the main body 12 is moved to a low end of the blocking portion 36, and slid onto the blocking portion 36 to move upwards, the friction between the shaft 10 and the first bracket 20 increases gradually. Accordingly, the cover 104 resists rotating relative to the base 102, which avoids the cover 104 bumping against the base 102 with too much force.

It is obvious that the fixing member 90 may be a threaded bolt or other fastener. If the fixing member 90 is a threaded bolt, an inner surface of the fastening hole 34 defines internal thread engagable with the bolt. Thereby, the first element is fixed to the second bracket.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A hinge comprising,
a first bracket;
a shaft, the first bracket being rotatably mounted on the shaft;
an interference assembly mounted to the shaft, the interference assembly comprising a first element, and a second element engaged with and capable of rotating relative to the first element and together with the shaft;
a biasing member mounted to the shaft;
a fastener fixed to a free end of the shaft, to prevent the interference assembly and the biasing member from disengaging from the shaft; and
a fixing member configured for passing through the first element to engage with the first bracket, resulting in fixing the first element to the first bracket.

2. The hinge of claim 1, wherein the first bracket defines a fastening hole, a fixing hole is defined in the first element, the fixing member is passed through the fixing hole to engage in the fastening hole.

3. The hinge of claim 2, wherein the fixing member is a rivet.

4. The hinge of claim 1, wherein the shaft comprises a main body, a non-circular fixing rod extending from a first end of the main body, and a stop portion protruding from a circumference of the main body;
the first bracket defines a through hole for the fixing rod rotatably passing therethrough, and a blocking portion extends from the first bracket and adjacent to the through hole; and
the stop portion is capable of resisting against the blocking portion.

5. The hinge of claim 4, wherein the blocking portion is wedge-shaped.

6. The hinge of claim 1, wherein the first element defines two depression portions, two raised portions protrude from the second element facing and engagable with the depressed portions.

7. The hinge of claim 6, wherein the first element defines a through hole in its center for the shaft rotatably passing through, the second element defines a fixing hole in its center for matching the shaft, the depression portions opposite to each other across the through hole, the raised portions opposite to each other across the fixing hole.

8. The hinge of claim 7, wherein each depressed portion comprises a first portion around the through hole, and a second portion along a circumference of the first element; one end of the first portion is opposite to and communicates with one end of the second portion.

9. The hinge of claim 7, wherein each raised portion comprises a first part around the fixing hole, and a second part along a circumference of the second element; one end of the first part is opposite to and communicates with one end of the second part.

10. The hinge of claim 1, further comprising a second bracket, wherein the second bracket defines a semicircular fixing hole; and the shaft comprises a main body and a semicircular conjoining portion extending from the main body, the semicircular conjoining portion is engaged in the semicircular fixing hole.

11. A collapsible device comprising:
a base;
a hinge comprising:
a first bracket;
a shaft, the first bracket being rotatably mounted on the shaft;
an interference assembly mounted to the shaft, the interference assembly comprising a first element, and a second element engaged with and capable of rotating relative to the first element and together with the shaft;
a biasing member mounted to the shaft;
a fastener fixed to a distal end of the shaft, to prevent the interference assembly and the biasing member from disengaging from the shaft; and
a fixing member configured for passing through the first element to engage with the first bracket, resulting in fixing the first element to the first bracket;
a cover pivotally mounted to the base via the hinge;
wherein the first bracket is fixed to one of the base and the cover, and the second element is fixed to the other one of the base and the cover.

12. The collapsible device of claim 11, wherein the first bracket defines a fastening hole, a fixing hole is defined in the first element, the fixing member is passed through the fixing hole to engage in the fastening hole.

13. The collapsible device of claim 12, wherein the fixing member is a rivet.

14. The collapsible device of claim 11, wherein the shaft comprises a main body, a non-circular fixing rod extending from a first end of the main body, and a stop portion protruding from a circumference of the main body;
the first bracket defines a through hole for the fixing rod rotatably passing therethrough, and a blocking portion extends from the first bracket and adjacent to the through hole; and
the stop portion is capable of resisting against the blocking portion.

15. The collapsible device of claim 14, wherein the blocking portion is wedge-shaped.

16. The collapsible device of claim 11, wherein the first element defines two depression portions, two raised portions protrude from the second element facing and engagable with the depressed portions.

17. The collapsible device of claim 16, wherein the first element defines a through hole in its center for the shaft rotatably passing through, the second element defines a fixing hole in its center for matching the shaft, the depression portions opposite to each other across the through hole, the raised portions opposite to each other across the fixing hole.

18. The collapsible device of claim 16, wherein each depressed portion comprises a first portion around the through hole, and a second portion along a circumference of the first element; one end of the first portion is opposite to and communicates with one end of the second portion.

19. The collapsible device of claim 16, wherein each raised portion comprises a first part around the fixing hole, and a second part along a circumference of the second element; one end of the first part is opposite to and communicates with one end of the second part.

20. The collapsible device of claim 11, wherein the hinge further comprising a second bracket, wherein the second bracket defines a semicircular fixing hole; and the shaft comprises a main body and a semicircular conjoining portion extending from the main body, the semicircular conjoining portion is engaged in the semicircular fixing hole.
